(19) United States
(12) Patent Application Publication
(10) Pub. No.: US 2009/0056299 A1
(43) Pub. Date: Mar. 5, 2009

(54) Tool Structure and Configurations

(76) Inventors: Harry S. Billado, JR., Portsmouth, NH (US); Jonathan Alan Marks, Sommerville, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/198,954

(22) Filed: Aug. 27, 2008

Related U.S. Application Data
(62) Division of application No. 11/463,224, filed on Aug. 8, 2006.

(51) Int. Cl. A01D 7/00; A01B 1/20; A01D 9/00; A01B 1/04; A01D 11/06

(52) U.S. Cl. 56/400.11; 56/400.17; 294/55.5; 294/51; 294/52

(57) ABSTRACT

An ergonomic yard or garden tool includes a generally straight handle and a head having a working portion and structural supports. The head includes an ergonomic bend angled away from the handle. The bend and the structural supports provide an offset between the working portion and an axis of the handle. The offset may reduce the amount of bending necessary to use the tool.

### CROSS-REFERENCE TO RELATED APPLICATIONS

This application is a divisional of U.S. patent application Ser. No. 11/463,224, filed Aug. 8, 2006, which claims the benefit of U.S. provisional patent application Ser. No. 60/706,384, filed on Aug. 8, 2005, the entire disclosures of which applications are incorporated herein by reference.

### FIELD

The present disclosure relates to rakes, shovels, and other applicable tools.

### BACKGROUND

Yard and garden tools often include a generally straight handle attached to a working portion, such as a rake head including teeth, a shovel scoop, etc. extending generally straight from the handle. This common design of yard and garden tools, such as rakes, shovels, etc., often requires the user to bend over, twist, etc. during use of the tool. Movements such as bending over may result in injury, especially after prolonged periods of use of the tools. Accordingly, it would be desirable to provide yard and garden tools which may reduce bending of the back during operation, and may also reduce any resulting injuries.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIGS. 1a and 1b depict an exemplary embodiment of a rake configuration consistent with the present invention;

FIGS. 2a-2c are exemplary embodiments of a shovel configuration consistent with the present invention;

FIGS. 3a and 3b show an exemplary embodiment of a rake design consistent with an aspect of the present invention; and

FIGS. 4a and 4b are an exemplary embodiment of another rake design consistent with the present invention.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

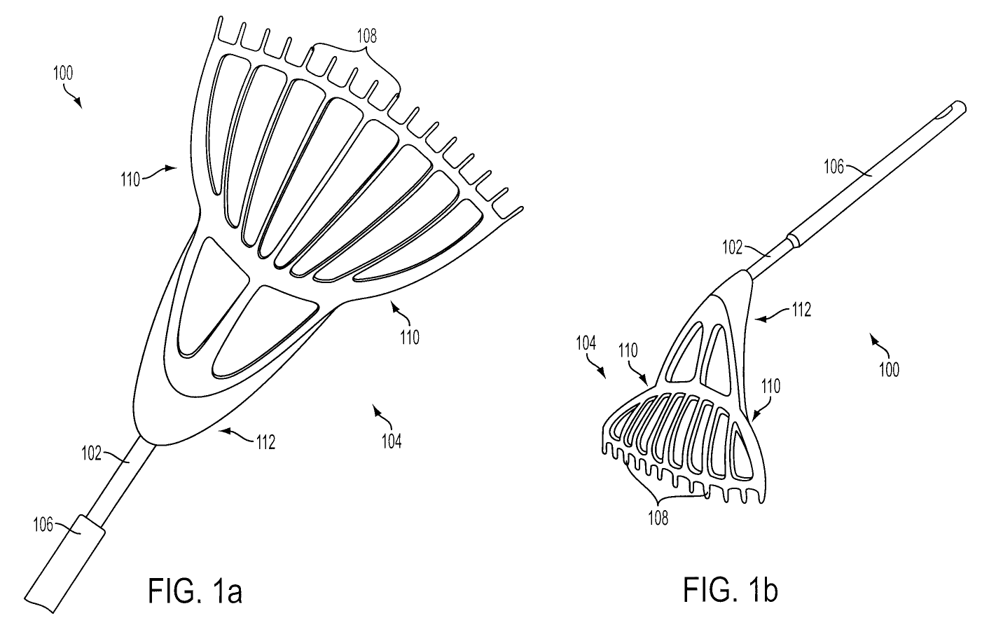

FIGS. 1a and 1b illustrate one exemplary embodiment of a rake 100 consistent with the present invention. The rake 100 may include a handle 102 connected to a head 104. The handle 102 may be composed of at least one piece of wood, plastic, metal, synthetic material or any combination of materials, fashioned in an unbent, generally straight manner that is connected to the head 104. The handle 102 may be padded 106 or shaped in a manner to make it more comfortable for the user to grip. The head 104 may include a working portion, such as rake teeth 108, structural support 110 and an “ergonomic bend” 112. In this particular embodiment, the head 104 may be composed of injected plastic, but the head 104 may be composed of one or more different materials, for instance, metal, plastic, synthetics, etc.

The “ergonomic bend” 112 may include a bend in the head 104 at a set angle towards the ground. The “ergonomic bend” 112 may, in conjunction with the structural supports 110, lower the teeth 108 towards the ground reducing the angle that the user needs to bend at to use the rake 100. In one such embodiment, the teeth 108 may be offset below the axis of the handle 102. The head may include additional bends to provide a desired orientation of the teeth relative to a working surface, such as the ground, to allow appropriate operation of the rake. The structural support 110 may include various features, such as ribs, spars, etc., to impart a desired degree of stiffness between the handle 102 and the teeth 108 to allow the use to apply a desired pressure to the teeth 108 through the handle 102.

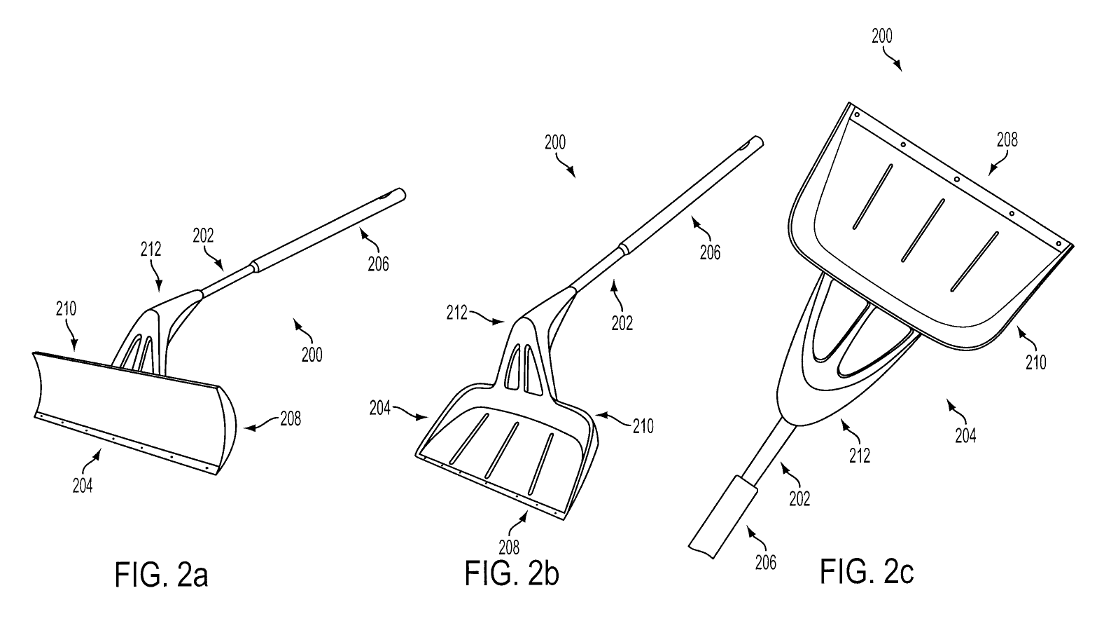

FIGS. 2a-2c illustrate exemplary embodiments of shovels 200 consistent with the present invention. A shovel 200 consistent with the present invention may include a handle 202 connected to a head 204. The handle 202 may be composed of at least one piece of wood, plastic, metal, synthetic or any combination of materials, fashioned in an unbent, generally straight manner that is connected to the head 204. The handle 202 may be padded 206 or shaped in a manner to make it more comfortable for the user to grip. In the illustrated embodiment, the head 204 of the shovel 200 may include a scoop 208, as a working portion, structural support 210 and an “ergonomic bend” 212. In the particular illustrated embodiments, the head 204 may be composed of injected plastic, but the head 204 may be composed of one or more different materials, for instance, metal, plastic, synthetics, etc.

Similar to the preceding embodiments of a rake including an “ergonomic bend”, the “ergonomic bend” 212 of the shovel 200 may include a bend in the head 204 at a set angle towards the ground. The “ergonomic bend” 212 may, in conjunction with the structural supports 210, lower the scoop 208 towards the ground reducing the angle that the user needs to bend at to use the shovel 200. The head may include additional bends relative to the scoop and/or the handle, which may provide a desired orientation of the scoop relative to the handle to facilitate operation of the shovel. The structural supports 210 may, in some embodiments, lower the scoop 208 toward the ground relative to the axis of the handle 202. Additionally, the structural supports 210 may impart sufficient stiffness to the head 204 to prevent excessive deflection of the scoop 208 during use. The degree of deflection of the scoop 208 may vary depending upon intended use, etc.

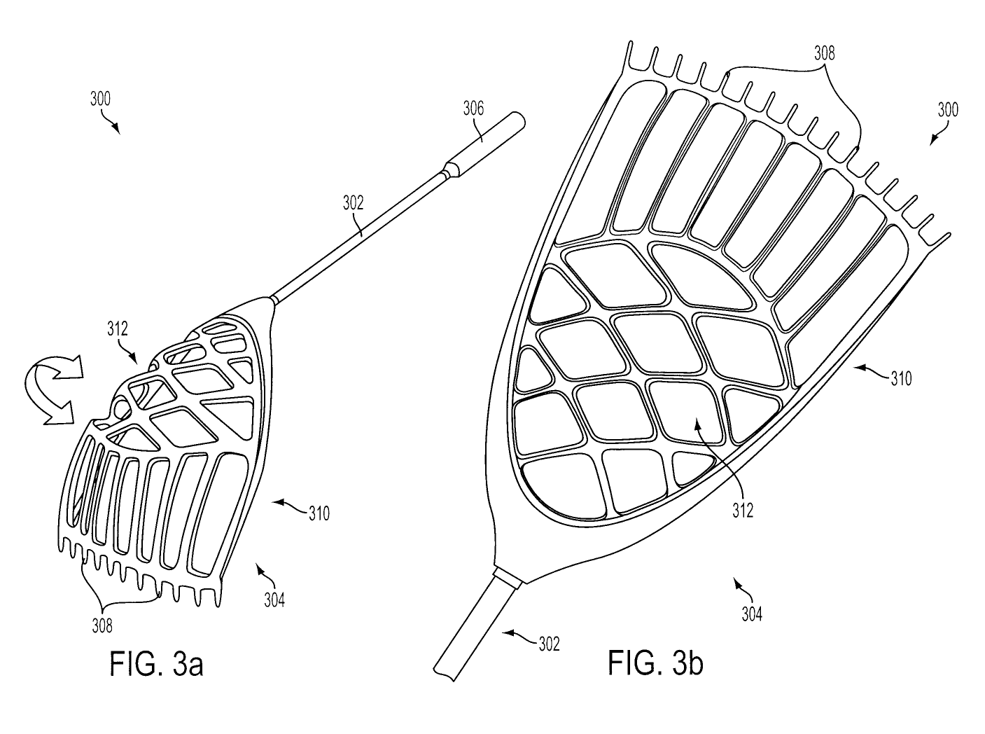

FIGS. 3a and 3b illustrate one exemplary embodiment of a multi-tasking rake 300 consistent with the present invention. The rake 300 may include a handle 302 connected to a head 304. The handle 302 may be composed of at least one piece of wood, plastic, metal, synthetic or any combination of materials, fashioned in an unbent, generally straight manner that is connected to the head 304. The handle 304 may be padded 306 or shaped in a manner to make it more comfortable for the user to grip. The head 304 may include teeth 308, structural support 310 and a scoop 312. In this particular embodiment, the head 304 may be composed of injected plastic, but the head 304 may be composed of one or more different materials, for instance, metal, plastic, synthetics, etc.

The head 304 may include both teeth 308 and a scoop 312, allowing the multi-tasking rake 300 to be used both as a rake and as a shovel. The scoop 312 may include a concave area, or region, of the head 304 between the teeth 308 and the handle 302. The scoop 312 may be disposed adjacent to the structural supports, or may include the structural supports 310. Additionally, as shown, at least a portion of the structural supports may define a perimeter of the scoop 312, and provide reinforcement. The scoop 312 may include an open structure including open regions, e.g., including intersecting members strong netting configured in a concave fashion. The open structure may create a depression that can pick up debris while allowing water and air through. Other open structures may include a perforated surface, a solid surface defining one or more cut-outs, non-intersecting members, etc. In alternative embodiments, the scoop may include a generally solid surface defining at least a portion of scoop. The generally solid surface may allow the scoop to pick up fine particles, such as sand or dirt, fluids, mixtures, such as mud or wet material, etc.

The multi-tasking rake 300 may include an “ergonomic bend”, e.g., defined by the scoop 312. As with previous embodiments, the “ergonomic bend” may, in conjunction with the structural supports 310 and/or at least a portion of the scoop 312, lower the rake teeth 308 towards the ground reducing the angle that the user needs to bend at to use the rake 300. Similarly, the “ergonomic bend” may also lower the scoop 312 portion of the multi-tasking rake 300 towards the ground reducing the angle that the user needs to bend at to use the scoop 312 portion of the rake 300. The head may include additional bends relative to the teeth and/or the handle, which may provide a desired orientation of the teeth and/or scoop relative to the handle to facilitate operation of the multi-tasking rake. The structural supports 310, and or the scoop 312, may, in some embodiments, lower the scoop teeth and scoop towards the ground relative to the axis of the handle 302.

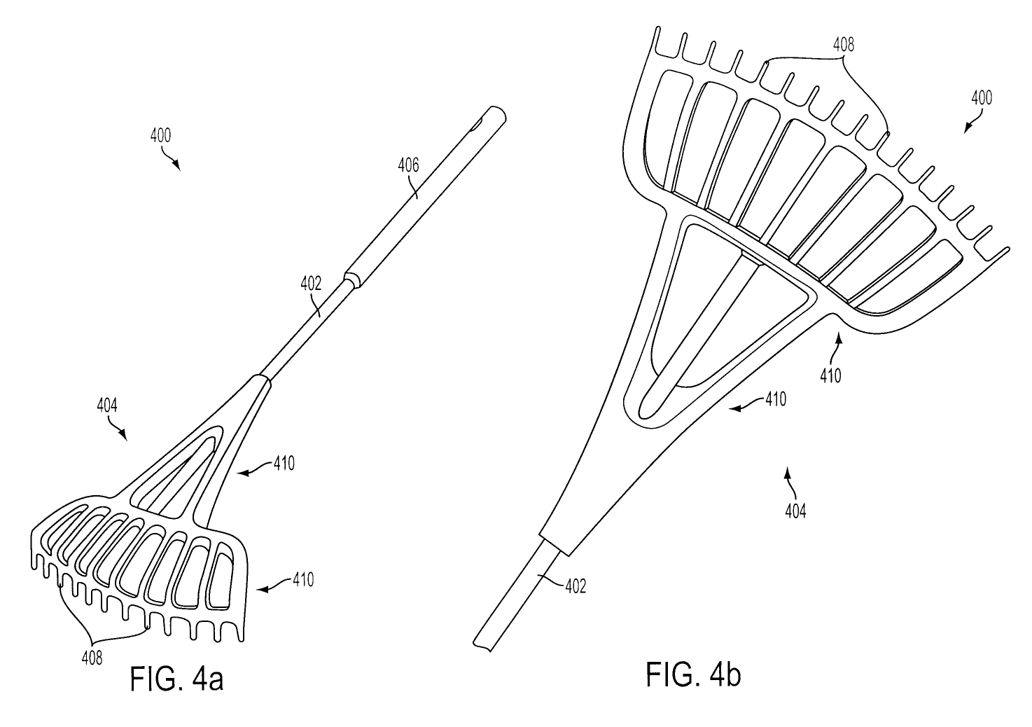

FIGS. 4a and 4b illustrate one exemplary embodiment of a rake 400 consistent with the present invention. The rake 400 may include a handle 402 connected to a head 404. The handle 402 may be composed of at least one piece of wood, plastic, metal, synthetic or any combination of materials, fashioned in an unbent, generally straight manner that is connected to the head 404. The handle 404 may be padded 406 or shaped in a manner to make it more comfortable for the user to grip. The head 404 may comprise teeth 408 and structural support 410. In this particular embodiment, the head 404 may be composed of injected plastic, but the head 404 may be composed of one or more different materials, for instance, metal, plastic, synthetics, etc. A first portion of the head 404 may be connected to the end of the handle 402 through a structural support 410 generally parallel to the teeth 408, creating improved leverage over tools like those shown in preceding figures. Additional structural supports 410 may extend along a portion of the handle 402, and the handle 402 may be connected to a second portion of the head 404, further supporting the rake 400 and creating greater leverage for the user.

In summary, according to a first aspect, the present invention may provide an ergonomic tool including a generally straight handle. The tool may further include a head having a working portion and at least one structural support. The head may further include an ergonomic bend angled away from the handle. The ergonomic bend and the at least one structural support may provide an offset between the working portion and an axis of the handle.

According to another aspect, the present invention may provide a tool including a handle and a head having a first portion including a plurality of teeth and a scoop including a concave region disposed between the teeth and the handle.

According to yet another aspect, the present invention may provide a rake including a generally straight handle. The rake may further include a rake head including a plurality of teeth and a structural support extending generally parallel to the plurality of teeth. The handle may be connected to a first and a second portion of the head, and the may extend through at least a portion of the structural supports.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A tool comprising:
an elongate handle; and
a head comprising
a first end coupled to said handle,
a second end comprising a plurality of teeth,
portions defining a concave scoop between said handle and said plurality of teeth,
a plurality of structural supports extending between said concave scoop and said plurality of teeth,
said concave scoop being angled away from an axis of said handle to provide an offset between said plurality of teeth and said axis of said handle.

2. The tool according to claim 1, wherein said scoop comprises an open structure defining at least one opening in said concave region.

3. The tool according to claim 1, wherein said scoop comprises a plurality of intersecting members defining openings therebetween.

4. The tool according to claim 1, wherein said scoop comprises a solid surface.

5. A tool comprising:
a handle; and
a head having a first end coupled to an end of said handle and a second end comprising a plurality of teeth, said head comprising portions defining a concave scoop between said end of said handle and said teeth for holding debris.

6. The tool according to claim 5, wherein said concave scoop is angled away from an axis of said handle to provide an offset between said plurality of teeth and said axis of said handle.

7. The tool according to claim 5, wherein said scoop comprises an open structure defining at least one opening in said concave region.

8. The tool according to claim 5, wherein said scoop comprises a plurality of intersecting members defining openings therebetween.

9. The combination tool according to claim 5, wherein said scoop comprises a solid surface.
